(19) United States
(12) Patent Application Publication
(10) Pub. No.: US 2015/0363402 A1
(43) Pub. Date: Dec. 17, 2015

(54) Statistical Filtering of Search Results on Online Social Networks

(71) Applicant: Facebook, Inc., Menlo Park, CA (US)

(72) Inventors: Thomas E. Jackson, Redmond, WA (US); Li-Tal Mashiach, Redmond, WA (US)

(21) Appl. No.: 14/304,596

(22) Filed: Jun. 13, 2014

(51) Int. Cl. G06F 17/30

(52) U.S. Cl. CPC G06F 17/3053; G06F 17/30867; G06Q 50/01

(57) ABSTRACT

In one embodiment, a method includes receiving a query from a first user of an online social network and identifying a set of objects associated with the online social network that substantially match the query. The method also includes calculating, for each identified object, multiple scores corresponding to multiple scoring axes, respectively, each scoring axis having a threshold score that is statistically determined for the scoring axis. The method further includes filtering one or more of the identified objects from the set of objects based on the calculated scores, where each filtered object is associated with one or more scores for one or more scoring axes, respectively, below the threshold score of the respective scoring axis. The method also includes generating one or more search results corresponding to one or more of the identified objects remaining in the set of objects, respectively.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, a social-networking system may receive a query from a user of an online social network hosted by the social-networking system. In response to the user's query, the social-networking system may identify a set of objects associated with the online social network that substantially match the query. The social-networking system may score each of the identified objects on a variety of criteria, which may be referred to as “axes” or “scoring axes.” Examples of scoring axes include degree of separation between social-graph nodes, social-graph affinity, social relevance, recency, topic relevance, author quality, text similarity, popularity, proximity, and a user's search history. As an example, for an axis based on degree of separation, an object that has one degree of separation with respect to the querying user may have a higher degree-of-separation score than an object that is two degrees of separation from the querying user. As another example, an object associated with a date of one week ago may have a higher score along a recency scoring axis than an object from one year ago.

In particular embodiments, each scoring axis may have a threshold score that is statistically determined for the scoring axis. A threshold score for a particular axis may be based on the mean of scores along the axis, a particular number of low-scoring objects, a particular percentage of low-scoring objects, or a step in scores along the axis. For example, a threshold score may be set at approximately two standard deviations below the mean of scores. As another example, a threshold score set at the 30th percentile of a set of 100 objects may have a value along a particular axis that is above the bottom 30 scores of the set and below the top 70 scores.

In particular embodiments, the social-networking system may filter out one or more of the identified objects from the set of objects based on the calculated scores and the threshold scores. The process of filtering out objects from a set of identified objects may remove low-scoring or low-quality objects from the set. An object may be filtered out from the set of identified objects if one or more of its scores are below one or more respective threshold scores. For example, a threshold score may be greater than or approximately equal to the 30th percentile of scores for a particular axis, and an object whose score is in the bottom 30% of scores may be removed from the set of identified objects. As another example, an object may be filtered out if it has two scores along two scoring axes that are both below the respective threshold scores for the two axes.

In particular embodiments, the social-networking system may generate one or more search results corresponding to one or more of the identified objects remaining in the set of objects, respectively. After going through the filtering process, the objects that remain may be objects with greater relevance to a user or a user's query. The search results may be ordered in any suitable manner, such as, for example, chronologically (e.g., more recent items listed first) or by score or ranking. In response to the user's query, the social-networking system may send one or more of the search results to the user.

The embodiments disclosed above are only examples, and the scope of this disclosure is not limited to them. Particular embodiments may include all, some, or none of the components, elements, features, functions, operations, or steps of the embodiments disclosed above.

### BRIEF DESCRIPTION OF THE DRAWINGS

FIG. 1 illustrates an example network environment associated with a social-networking system.

FIG. 2 illustrates an example social graph.

FIG. 3 illustrates an example set of N objects identified in response to a query.

FIG. 4 illustrates an example set of seven objects identified in response to a query.

FIG. 5 illustrates an example method for generating search results in response to a query.

FIG. 6 illustrates an example computer system.

### DESCRIPTION OF EXAMPLE EMBODIMENTS

### System Overview

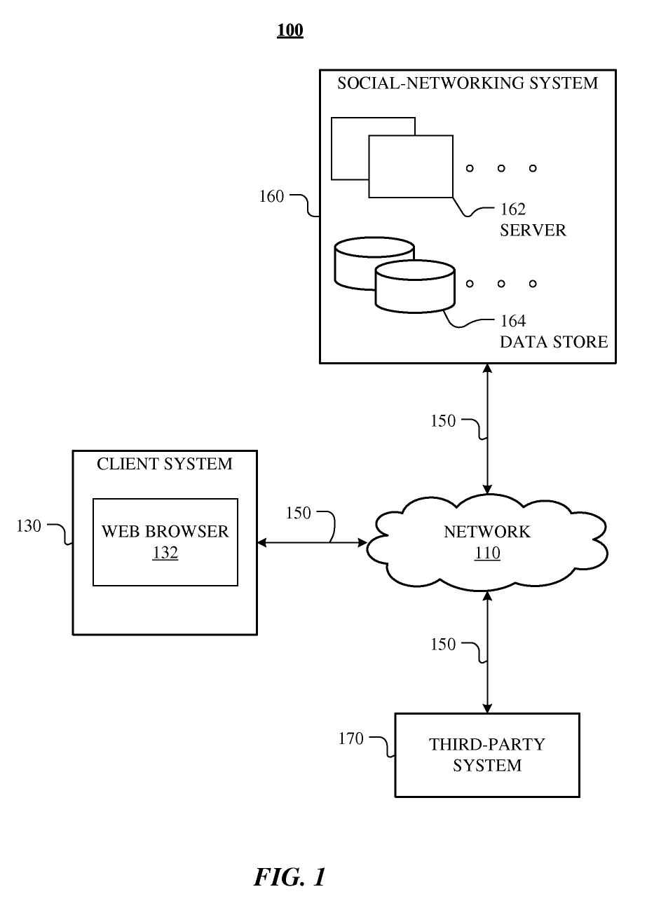

FIG. 1 illustrates an example network environment 100 associated with a social-networking system. Network environment 100 includes client system 130, social-networking system 160, and third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. Client system 130 may enable a network user at client system 130 to access network 110. Client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable client system 130, social-networking system 160, or third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (i.e., relationships) to a number of other users of social-networking system 160 whom they want to be connected to. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, third-party system 170 may include a third-party content object provider. A third-party content object provider may include one or more sources of content objects, which may be communicated to client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, ad-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to client system 130. Information may be pushed to client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in or opt out of having their actions logged by social-networking system 160 or shared with other systems (e.g., third-party system 170), such as, for example, by setting appropriate privacy settings. Third-party-content-object stores may be used to store content objects received from third parties, such as third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

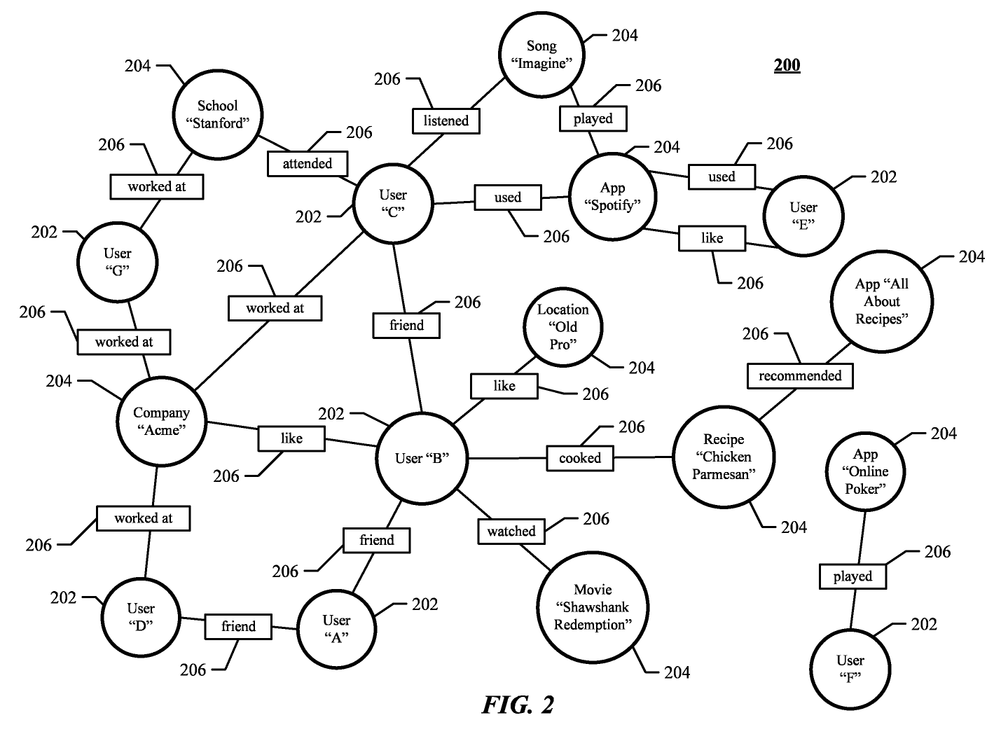

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example and not by way of limitation, a concept may correspond to a place (such as, for example, a movie theater, restaurant, landmark, or city); a website (such as, for example, a website associated with social-networking system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing client system 130 to send to social-networking system 160 a message indicating the user's action. In response to the message, social-networking system 160 may create an edge (e.g., an “eat” edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 24. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example and not by way of limitation, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries

In particular embodiments, social-networking system 160 may receive a query from a user of an online social network hosted by social-networking system 160. A user may submit a query to social-networking system 160 by inputting text into a query field. A user of an online social network may search for information relating to a specific subject matter (e.g., users, concepts, external content or resources) by providing one or more keywords or a short phrase describing the subject matter, often referred to as a “search query,” to a search engine associated with social-networking system 160. The query may be an unstructured text query and may comprise one or more text strings (which may include one or more n-grams). As used herein, an unstructured text query refers to a simple text string inputted by a user. In general, a querying user may input any suitable character string into a query field to search for content on social-networking system 160 that matches the text query. Although this disclosure describes querying social-networking system 160 in a particular manner, this disclosure contemplates querying social-networking system 160 in any suitable manner.

In particular embodiments, social-networking system 160 may receive from a querying/first user (corresponding to a first user node 202) an unstructured text query. As an example and not by way of limitation, a first user may want to search for other users who: (1) are first-degree friends of the first user; and (2) are associated with Stanford University (i.e., the user nodes 202 are connected by an edge 206 to the concept node 204 corresponding to the school “Stanford”). The first user may then enter a text query “friends stanford” into a query field. The text query may, of course, be structured with respect to standard language/grammar rules (e.g. English language grammar). However, the text query will ordinarily be unstructured with respect to social-graph elements. In other words, a simple text query will not ordinarily include embedded references to particular social-graph elements. Thus, as used herein, a structured query refers to a query that contains references to particular social-graph elements, allowing the search engine to search based on the identified elements. Furthermore, the text query may be unstructured with respect to formal query syntax. In other words, a simple text query will not necessarily be in the format of a query command that is directly executable by a search engine (e.g., the text query “friends stanford” could be parsed to form the query command “intersect(school(Stanford University), friends(me))”, which could be executed as a query in a social-graph database). Although this disclosure describes receiving particular queries in a particular manner, this disclosure contemplates receiving any suitable queries in any suitable manner.

In particular embodiments, social-networking system 160 may parse the unstructured text query (also simply referred to as a search query) received from the first user (i.e., the querying user) to identify one or more n-grams. In general, an n-gram is a contiguous sequence of n items from a given sequence of text or speech. The items may be characters, phonemes, syllables, letters, words, base pairs, prefixes, or other identifiable items from the sequence of text or speech. The n-gram may comprise one or more characters of text (letters, numbers, punctuation, etc.) entered by the querying user. Each n-gram may include one or more parts from the text query received from the querying user. In particular embodiments, each n-gram may comprise a character string (e.g., one or more characters of text) entered by the first user. As an example and not by way of limitation, social-networking system 160 may parse the text query “friends stanford” to identify the following n-grams: friends; stanford; friends stanford. Although this disclosure describes parsing particular queries in a particular manner, this disclosure contemplates parsing any suitable queries in any suitable manner.

In particular embodiments, in response to a query from a user, social-networking system 160 may identify a set of objects associated with an online social network hosted by social-networking system 160 that substantially match the query. In particular embodiments, social-networking system 160 may search a data store 164 (or, in particular embodiments, a social-graph database) to identify objects matching the query. In particular embodiments, a search engine associated with social-networking system 160 may conduct a search based on the query phrase using various search algorithms and identify resources, objects, or content (e.g., user-profile pages, content-profile pages, or external resources) that are most likely to be related to the search query. In particular embodiments, a search algorithm may be based on social-graph elements referenced in the search query, terms within the search query, user information associate with the querying user, search history of the querying user, pattern detection, other suitable information related to the query or the user, or any combination thereof. In particular embodiments, the resources, objects, or content identified by social-networking system 160 in response to a search query may be referred to as “search results” or “identified objects” corresponding to the search query. The identified objects may include, for example, social-graph elements (i.e., user nodes 202, concept nodes 204, edges 206), profile pages (or content of profile pages), posts, comments, messages, event listings, user groups, news stories, headlines, instant messages, chat room conversations, emails, advertisements, coupons, pictures, video, music, external webpages, other suitable objects, or any suitable combination thereof. Although this disclosure describes particular types of identified objects, this disclosure contemplates any suitable types of identified objects. In particular embodiments, the search engine may limit its search to resources, objects, or content on the online social network. However, in particular embodiments, the search engine may also search for resources or contents on other sources, such as third-party system 170, the internet or World Wide Web, or other suitable sources. Although this disclosure describes generating particular search results in a particular manner, this disclosure contemplates generating any suitable search results in any suitable manner.

In particular embodiments, after identifying a set of objects associated with a query, social-networking system 160 may calculate a plurality of scores for each identified object. In particular embodiments, the identified objects may be scored or ranked based on one or more scoring/ranking algorithms. As an example and not by way of limitation, objects that are more relevant to the search query or to the user may be scored higher than objects that are less relevant. Based on the calculated scores, social-networking system 160 may filter one or more of the identified objects from the set of objects. A filtering process may enhance search quality by removing or filtering out low-scoring or low-quality objects from the set of objects. In particular embodiments, social-networking system 160 may generate one or more search results corresponding to the identified objects remaining in the set of objects, and in response to the query, social-networking system 160 may send one or more of the search results for display to the user.

In particular embodiments, a typeahead process may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays references to the matching profile pages (e.g., a name or photo associated with the page) of the respective user nodes 202 or concept nodes 204, and displays names of matching edges 206 that may connect to the matching user nodes 202 or concept nodes 204, which the user can then click on or otherwise select, thereby confirming the desire to search for the matched user or concept name corresponding to the selected node, or to search for users or concepts connected to the matched users or concepts by the matching edges. Alternatively, the typeahead process may simply auto-populate a field or form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and/or edges, the typeahead process may send a request that informs social-networking system 160 of the user's confirmation of a query containing the matching social-graph elements. In response to the sent request, social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, and U.S. patent application Ser. No. 12/978,265, filed 23 Dec. 2010, each of which is incorporated by reference.

### Scoring Identified Objects

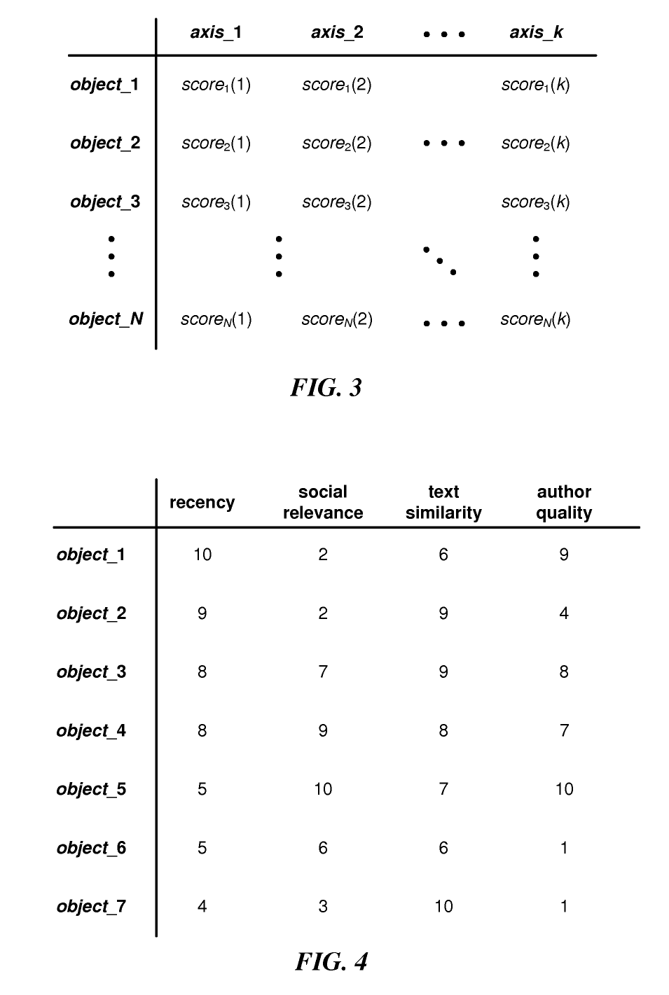

FIG. 3 illustrates an example set of N objects identified in response to a query. In particular embodiments, in response to a search query, social-networking system 160 may identify any suitable number of objects that substantially match the query (e.g., N=10, 100, 1000, etc.). In the example of FIG. 3, each object of object_1 through object_N corresponds to an object identified by social-networking system 160 as likely to be related to a search query. In particular embodiments, social-networking system 160 may score or rank each of the identified objects based on a variety of factors or criteria, which may be referred to as “axes” or “scoring axes.” In particular embodiments, social-networking system 160 may calculate, for each identified object, a plurality of scores corresponding to a plurality of scoring axes, respectively. In FIG. 3, each identified object of the set of N identified objects is scored across k scoring axes (i.e., axis_1 through axis_k). As an example, object_1 in FIG. 3 is associated with scores scoreᵢ(1) through score₁(k), and each score is associated with a particular axis. For example, scoreᵢ(2) in FIG. 3 is associated with object_1 and scoring axis axis_2. In particular embodiments, each scoring axis may be associated with a particular criteria used to calculate a score. As an example and not by way of limitation, a score associated with a particular scoring axis may be determined based on social-graph information (such as, for example, degree of separation between social-graph nodes, social-graph affinity, or social relevance, each of which may be its own axis), recency, topic relevance, author quality, text similarity, popularity, proximity, a user's search history, or other suitable criteria, or any suitable combination thereof. In particular embodiments, for a set of identified objects scored with respect to a plurality of scoring axes, each axis may use a different ranking or scoring model to score objects. As an example and not by way of limitation, a first axis may score objects based on recency, while a second axis may score objects based on author quality. Although this disclosure describes and illustrates particular scoring axes associated with particular criteria used to determine scores, this disclosure contemplates any suitable scoring axes associated with any suitable criteria used to determine scores.

In particular embodiments, social-networking system 160 may access a social graph 200 comprising a plurality of nodes and a plurality of edges 206 connecting the nodes, each of the edges 206 between two of the nodes representing a single degree of separation between them. In particular embodiments, a querying user may correspond to a particular user node 202 of a social graph 200, and each identified object may correspond to a particular node of a social graph 200. In particular embodiments, for each identified object, a score corresponding to a particular scoring axis may be based at least in part on social-graph information associated with a querying user and the identified object. As an example and not by way of limitation, a score corresponding to a particular scoring axis may be based at least in part on a degree of separation between the user node 202 of the querying user and a node corresponding to the identified object. Objects that reference social-graph elements that are closer in the social graph 200 to the querying user (i.e., fewer degrees of separation between the element and the querying user's user node 202) may be scored or ranked more highly than objects that are further from the user (i.e., more degrees of separation). In the example of FIG. 2, user nodes 202 of user “A” and user “B” have a single degree of separation, and user nodes 202 of user “B” and user “D” have two degrees of separation. Based on the degrees of separation, a degree-of-separation score for user “B” with respect to user “A” may be higher than a score for user “B” with respect to user “D.” Although this disclosure describes scoring objects based on degree of separation in a particular manner, this disclosure contemplates scoring objects based on degree of separation in any suitable manner. Furthermore, although this disclosure describes and illustrates particular scoring axes based on particular social-graph information, this disclosure contemplates any suitable scoring axes based on any suitable social-graph information.

In particular embodiments, for each identified object, a score corresponding to a particular scoring axis may be based at least in part on a social-graph affinity associated with the querying user (or the user node 202 of the querying user) with respect to the identified object (or a node associated with the identified object). As an example and not by way of limitation, in response to a query “Photos of my friends,” social-networking system 160 may determine that the search intent of this query is to view group photos showing the user's friends. When scoring identified concept nodes 204 corresponding to photos with the user's friends tagged in the photo, social-networking system 160 may score photos based on the social-graph affinity (e.g., as measured by an affinity coefficient) of the users tagged in the photo with respect to the querying user. Furthermore, photos showing more of the querying user's friends may have a higher affinity score than photos showing fewer of the user's friends, since having more friends tagged in the photo may increase the querying user's affinity with respect to that particular photo. As another example and not by way of limitation, in response to a query from a user <Mark>, social-networking system 160 may identify a set of objects that includes users <Tom>, <Dick>, and <Harry>. Social-networking system 160 may then score the users <Tom>, <Dick>, and <Harry> based on their respective social affinity with respect to the querying user <Mark>. For example, social-networking system 160 may score the identified nodes of users <Tom>, <Dick>, and <Harry> based in part on a number of posts authored by those users and liked by the user <Mark>. If user <Dick> authored three posts that were liked by the user <Mark>, user <Tom>authored two posts liked by <Mark>, and user <Harry> authored one post like by <Mark>, social-networking system 160 may score user <Dick> as highest with respect to an affinity-score axis since he authored most of the posts liked by the user <Mark>, with <Tom> and <Harry>having consecutively lower scores. Although this disclosure describes scoring objects based on affinity in a particular manner, this disclosure contemplates scoring objects based on affinity in any suitable manner.

In particular embodiments, for each identified object, a score corresponding to a particular scoring axis may be based at least in part on a social relevance of the identified object to the querying user. Objects that reference social-graph elements that are more closely connected or otherwise relevant to the querying user may be scored more highly than objects that reference social-graph elements that are not as closely connected or are otherwise less relevant to the querying user. As an example and not by way of limitation, the social relevance of a particular node may be based on the number of edges 206 connected to the node, such that an object referencing a node connected by more edges 206 may be scored or ranked higher than another object referencing another node connected by fewer edges 206. As another example and not by way of limitation, the social relevance of a particular edge 206 or edge-type may be based on the frequency of that edge-type being connected to particular nodes. In particular embodiments, identified objects associated with social-graph elements that the querying user has previously accessed, or are relevant to the social-graph elements the querying user has previously accessed, may be more likely to be the target of the querying user's search query. Thus, these identified objects may be scored or ranked more highly. As an example and not by way of limitation, if the querying user has previously visited the “Stanford University” profile page but has never visited the “Stanford, Calif.” profile page, when determining the score or rank for objects referencing these concepts, social-networking system 160 may determine that the object referencing the concept node 204 for “Stanford University” has a relatively high social-relevance score or rank because the querying user has previously accessed the concept node 204 for the school. In particular embodiments, social-networking system 160 may score or rank identified objects based at least in part on advertising sponsorship. An advertiser (such as, for example, the user or administrator of a particular profile page corresponding to a particular node) may sponsor a particular node such that an object associated with that node may be scored or ranked more highly. Although this disclosure describes scoring objects based on social relevance in a particular manner, this disclosure contemplates scoring objects based on social relevance in any suitable manner. Moreover, although this disclosure describes scoring search results based on social-graph information in a particular manner, this disclosure contemplates scoring search results based on social-graph information in any suitable manner.

In particular embodiments, for each identified object, a score corresponding to a particular scoring axis may be based at least in part on a recency value associated with the identified object. In particular embodiments, a recency value may correspond to how recently an associated object was generated, created, posted, sent, received, viewed, or commented on. For example, a recency value associated with an identified object may be determined based on a time or date associated with the object compared with the current time or date. Objects associated with more recent dates may have higher recency-value scores than objects associated with dates further in the past. As an example and not by way of limitation, an identified object that was posted two days ago may have a relatively high recency-value score (e.g., 9 out of 10), while another identified object that was posted a year ago may have a relatively low recency-value score (e.g., 2 out of 10). In particular embodiments, a recency value may correspond to a time or date associated with a future event or activity, and an event occurring sooner in the future may have a higher recency-value score than an event happening further in the future. As an example and not by way of limitation, an identified object corresponding to a party happening tomorrow may have a higher recency-value score than another identified object corresponding to a concert happening two weeks in the future. Although this disclosure describes scoring objects based on recency values in a particular manner, this disclosure contemplates scoring objects based on recency values in any suitable manner.

In particular embodiments, for each identified object, a score corresponding to a particular scoring axis may be based at least in part on a calculated topic relevance for the identified object with respect to a query or with respect to a querying user. As an example and not by way of limitation, a querying user may have liked, subscribed to, or searched for objects associated with particular topics or subject matters in the past. An identified object associated with a topic a user has previously liked or searched for may receive a higher topic-relevance score than another identified object associated with a topic having less relevance to the querying user. For example, a user may have subscribed to a scuba-diving discussion group, and if the user submits a query related to vacations in the Caribbean, identified objects associated with scuba diving may have a higher topic-relevance score than other identified objects. As another example and not by way of limitation, an identified object associated with a trending or popular topic may have a higher topic-relevance score than another identified object associated with a less-popular topic. Although this disclosure describes scoring objects based on topic relevance in a particular manner, this disclosure contemplates scoring objects based on topic relevance in any suitable manner.

In particular embodiments, for each identified object, a score corresponding to a particular scoring axis may be based at least in part on a calculated author quality associated with the identified object. An identified object may have a higher author-quality score if it is associated with a popular author, while another identified object associated with a less popular author may have a lower author-quality score. In particular embodiments, an author-quality score may be based in part on a number of “likes” or views an author has received or a measure of the author's global popularity on the online social network. In particular embodiments, an author-quality score may be based in part on a number of connecting edges 206 to nodes associated with a particular author. For example, an author associated with nodes having more connecting edges 206 may be more popular and may have a higher author-quality score than another author associated with nodes having fewer connecting edges 206. In particular embodiments, an author-quality score may be based in part on an author's popularity with respect to the querying user or friends of the querying user. For example, an identified object associated with an author who has received a greater number of “likes” from friends of a querying user may receive a higher author-quality score than another author who has received fewer “likes” from friends of the querying user. Although this disclosure describes scoring objects based on author quality in a particular manner, this disclosure contemplates scoring objects based on author quality in any suitable manner.

In particular embodiments, for each identified object, a score corresponding to a particular scoring axis may be based at least in part on a calculated text similarity between the identified object and a query. The text similarity or textual relevance of a query may be based on how the terms and number of terms in the query match to text associated with an identified object. In particular embodiments, a text-similarity score may be based on matches between a query and words or phrases associated with an identified object (e.g., summary, subject, title, author, keywords, or body of text associated with an identified object). In particular embodiments, a text-similarity score may be based on a number of text matches between a query and text associated with an identified object. As an example and not by way of limitation, an identified object that includes 80% of the terms of a query may have a higher text-similarity score than another identified object that includes 50% of the terms. As another example and not by way of limitation, if a user submits a query “Hawaii bike rides,” a post that includes the phrase “bike rides in Hawaii” may have a relatively high text-similarity score (e.g., 10 out of 10), while a post that includes the phrase “bike-riding vacations” may have a lower text-similarity score (e.g., 6 out of 10). In particular embodiments, a text-similarity score may be based on a number of times text from a query occurs in text associated with an identified object. For example, if a user submits a query “coffee shops in San Francisco,” an identified object that includes the terms “coffee” or “coffee shop” 50 times may have a higher text-similarity score than another identified object that includes “coffee” 10 times. Although this disclosure describes scoring objects based on text similarity in a particular manner, this disclosure contemplates scoring objects based on text similarity in any suitable manner.

### Filtering Identified Objects

FIG. 4 illustrates an example set of seven objects identified in response to a query. In the example of FIG. 4, the seven identified objects (object_1 through object_7) are scored with respect to four scoring axes (recency, social relevance, text similarity, and author quality). Although this disclosure describes and FIG. 4 illustrates scoring identified objects with respect to particular types and particular numbers of scoring axes, this disclosure contemplates scoring identified objects with respect to any suitable types and any suitable numbers of scoring axes. The scores in FIG. 4 are in a range or scoring scale from 0 to 10, where a minimum score of 0 represents little or no match or similarity between an object and a scoring axis and a maximum score of 10 represents a good or perfect match between an object and a scoring axis. In particular embodiments, scores associated with a particular scoring axis may be associated with a particular scoring scale or range. As an example and not by way of limitation, scores may be calculated on a scale or range of 0 to 1, 1 to 5, 0% to 100%, 100 to 1000, or on any suitable scoring scale. In particular embodiments, scores associated with a particular scoring axis may not have any particular or fixed scoring scale or may be scored according to an arbitrary scoring scale. In particular embodiments, scores associated with two different scoring axes may have the same scoring scale or may have different scoring scales. In particular embodiments, scores associated with a particular scoring axis may be calculated on an initial scoring scale, and then the scores may be normalized or mapped to another scoring scale. As an example and not by way of limitation, scores for a particular scoring axis may have an initial range of 100 to 500, and those scores may be normalized to a scoring scale with a range of 0 to 10 or 0% to 100%. Although this disclosure describes and FIG. 4 illustrates particular scores associated with particular scoring scales, this disclosure contemplates any suitable scores associated with any suitable scoring scales.

In particular embodiments, after identifying and calculating scores for a set of objects that substantially match a user's query, social-networking system 160 may filter one or more of the identified objects from the set based on the calculated scores. In particular embodiments, filtering an object from the set of objects may include identifying an object based on one or more of its associated scores and removing or deleting that object from the set of objects. In particular embodiments, each scoring axis may have an associated threshold score that is statistically determined for the scoring axis. As an example and not by way of limitation, a threshold score for a scoring axis may be based on a mean or median of a set of calculated scores. As another example and not by way of limitation, a threshold score may correspond to a particular score. For example, a scoring axis with a scoring scale of 0 to 10 may have a threshold score of 7. As yet another example and not by way of limitation, a threshold score may be set to a particular percentile of a difference between a maximum and minimum score. For example, a scoring axis with a scoring scale of 0 to 100 may have a threshold score set to 60% of the difference between 0 and 100 (i.e., 60). In particular embodiments, social-networking system 160 may determine a threshold score for each scoring axis, where the threshold score is based at least in part on the calculated scores associated with the scoring axis. As an example and not by way of limitation, a threshold score may be based on a particular number or a particular percentage of identified objects associated with a scoring axis. For example, a threshold score may be set at a 40th percentile of scores associated with a scoring axis so that approximately 40% of the scores are below the threshold score and approximately 60% of the scores are above the threshold score. In particular embodiments, each filtered object may be associated with one or more scores for one or more scoring axes, respectively, below the threshold score of the respective scoring axis. As an example and not by way of limitation, an identified object may be filtered from the set of identified objects if its score for a particular scoring axis is below the threshold score for that scoring axis. As another example and not by way of limitation, an identified object may be filtered from the set of identified objects if its scores for two scoring axes are below the respective threshold scores for those two scoring axes. In particular embodiments, each scoring axis associated with a set of identified objects may have a particular threshold score, and threshold scores for two or more scoring axes may be determined in a similar manner or in different manners. As an example and not by way of limitation, a first scoring axis may have a threshold score based on a mean of scores associated with that axis, and a second scoring axis may have a threshold score based on a particular percentage of objects associated with that axis. As another example and not by way of limitation, two scoring axes may each have threshold scores determined based on a mean of scores associated with each axis. Although this disclosure describes particular objects filtered from a set of identified objects based on particular threshold scores, this disclosure contemplates any suitable objects filtered from a set of identified objects based on any suitable threshold scores. Moreover, although this disclosure describes particular threshold scores determined in a particular manner, this disclosure contemplates any suitable threshold scores determined in any suitable manner.

In particular embodiments, a threshold score associated with a scoring axis may be based on a mean or standard deviation of scores associated with the scoring axis. In particular embodiments, a threshold score associated with a scoring axis may be a number of standard deviations above or below a mean of scores associated with the scoring axis. As an example and not by way of limitation, a threshold score s_{threshold} associated with a scoring axis may be expressed as s_{threshold}=s_{avg}−T×s_{SD}, where s_{avg} is the mean (or, average) of scores associated with the scoring axis, s_{SD} is the standard deviation of the scores, and T is a suitable constant representing the number of standard deviations. For example, a threshold score defined as two standard deviations below a mean of scores may be expressed as s_{threshold}=s_{avg}2×s_{SD}. As another example, a threshold score defined as one-half standard deviation above a mean of scores may be expressed as s_{threshold}=s_{avg}+0.5×s_{SD}. As yet another example, a threshold score defined as zero standard deviations away from a mean of scores may be expressed as s_{threshold}=s_{avg} so that the threshold score equals the mean of scores. In the example of FIG. 4, the scores associated with the text-similarity axis (i.e., 6, 9, 9, 8, 7, 6, and 10) have a mean of approximately 7.86 and a standard deviation of approximately 1.46. If the text-similarity axis has a threshold score defined as one standard deviation below the mean score, then the threshold score for the text-similarity axis is approximately 7.86−1.46=6.4. Based on a filtering operation that removes objects with scores below a threshold score, a threshold score of 6.4 for the text-similarity axis may result in the removal of object_1 and object_6 from the set of identified objects. Although this disclosure describes filtering particular objects based on a threshold score determined from a particular combination of a mean and standard deviation, this disclosure contemplates filtering any suitable objects based on a threshold score determined from any suitable combination of a mean and standard deviation.

In particular embodiments, a threshold score associated with a scoring axis may be based on a particular percentage of scores associated with the scoring axis. In particular embodiments, a threshold score may be greater than a particular percentage of scores associated with a scoring axis. As an example and not by way of limitation, a threshold score may be greater than approximately 20%, 30%, 40%, 50%, or any suitable percentage of scores associated with a particular scoring axis. For example, a threshold score set at approximately the 30th percentile of a set of 200 scores may result in the filtering of objects associated with the lowest 30% of scores (or the lowest 60 scores) from the set. In the example of FIG. 4, a threshold score associated with the author-quality axis may be greater than approximately 45% of the scores for that axis, or greater than the three lowest scores. In this case, a threshold score greater than approximately 45% of the scores may have a value of 5, and the three objects with author-quality scores below 5 (object_2, object_6, and object_7) may be filtered from the set of seven identified objects. Although this disclosure describes filtering particular objects based on particular percentages of scores associated with a scoring axis, this disclosure contemplates filtering any suitable objects based on any suitable percentages of scores associated with a scoring axis.

In particular embodiments, a threshold score associated with a scoring axis may be based on a particular number of scores associated with the scoring axis. In particular embodiments, a threshold score may be greater than a particular number of scores associated with a scoring axis. As an example and not by way of limitation, a threshold score may be greater than the lowest 5, 10, 50, 100, 200, or any suitable number of scores associated with a particular scoring axis. For example, a threshold score may be greater than the lowest 100 scores of a set of 300 scores, resulting in the filtering of objects associated with the lowest 100 scores from the set of identified objects. In the example of FIG. 4, a threshold score associated with the social-relevance axis may be set to approximately 6.5 so that it is greater than the lowest four scores. In this case, the four objects associated with scores below 6.5 (object_1, object_2, object_6, and object_7) may be filtered from the set of identified objects. Although this disclosure describes filtering particular objects based on particular numbers of scores associated with a scoring axis, this disclosure contemplates filtering any suitable objects based on any suitable numbers of scores associated with a scoring axis.

In particular embodiments, a threshold score associated with a scoring axis may be based on a step function associated with the scores for that scoring axis. A step function, or step, may refer to a notable, significant, or sudden drop or gap in scores associated with a particular scoring axis. In the example of FIG. 4, the scores associated with the recency axis exhibit a step between scores 5 and 8. Applying a step function analysis to the recency-axis scores may result in a threshold score of 6, and object_5, object_6, and object_7, which fall below the step function, may be filtered from the set of identified objects. In particular embodiments, scores associated with a particular scoring axis may exhibit two or more distinct step functions, and a step-function algorithm may determine a threshold score based on one or more of the step functions. As an example and not by way of limitation, a scoring axis that exhibits two or more distinct step functions may have a threshold score determined based on the step function with the largest amplitude (or difference between high and low scores across the step). As other example, a scoring axis with two or more distinct step functions may have a threshold score based on the step function associated with a lowest or highest score. Although this disclosure describes filtering particular objects based on particular step functions associated with a scoring axis, this disclosure contemplates filtering any suitable objects based on any suitable step functions associated with a scoring axis.

In particular embodiments, an identified object may be filtered from a set of identified objects if it is associated with two or more scores for two or more scoring axes, respectively, below the threshold scores of the scoring axes. As an example and not by way of limitation, an identified object associated with two scores for two scoring axes may be filtered if each score is below the threshold score for each respective scoring axis. In the example of FIG. 4, the recency axis may have a threshold score of 6, and the author-quality axis may have a threshold score of 5. An object may be filtered if its scores for both the recency axis and the author-quality axis are below the respective threshold scores for those two axes. In this case, object_6 and object_7 may be filtered from the set of identified objects. Even though object_5 has a recency score of 5 that is below the recency-axis threshold score of 6, object_5 may not be filtered because its score along the author-quality axis is 10, which is greater than the author-quality threshold score of 5. Similarly, even though object_2 has an author-quality score of 4 that is below the author-quality threshold score of 5, object_2 may not be filtered because its score along the recency axis is 9, which is greater than the recency threshold score of 6. Although this disclosure describes filtering particular objects based on a particular number of scores below respective threshold scores, this disclosure contemplates filtering any suitable objects based on any suitable number of scores below respective threshold scores.

In particular embodiments, scores for identified objects may be considered serially with respect to each scoring axis, and objects may be filtered as each scoring axis is considered. As an example and not by way of limitation, each scoring axis may be considered one at a time, and objects with scores below a threshold score for each scoring axis may be filtered. In particular embodiments, some scores for identified objects may be considered serially with respect to some scoring axes, and some scores may be considered in parallel with respect to other scoring axes. As an example and not by way of limitation, in FIG. 4, the recency and social-relevance scoring axes may be considered separately, while the text-similarity and author-quality scoring axes may be considered together so that an object must have scores below both text-similarity and author-quality threshold scores in order to be filtered based on those two axes. Although this disclosure describes filtering objects based on particular combinations of scoring axes, this disclosure contemplates filtering objects based on any suitable combinations of scoring axes.

### Retaining Identified Objects

In particular embodiments, after identifying and calculating scores for a set of objects that substantially match a user's query, social-networking system 160 may retain in the set of objects one or more of the identified objects whose scores associated with one or more scoring axes are above one or more respective upper-threshold scores. In particular embodiments, retaining an object in a set of identified objects may include keeping the object in the set if one or more of its scores is greater than one or more respective upper-threshold scores. As an example and not by way of limitation, an object may be retained in the set of objects if one of its scores is greater than an upper-threshold score. In the example of FIG. 4, the recency axis may have an upper-threshold score of 9, and object_1 may be retained since its recency score (10) is greater than the upper-threshold score. In particular embodiments, retaining an object in a set of identified objects may include not filtering the object from the set even though one or more of its other scores associated with one or more scoring axis may be below respective threshold scores for those axes. Although this disclosure describes particular objects retained in a set of identified objects based on particular upper-threshold scores, this disclosure contemplates any suitable objects retained in a set of identified objects based on any suitable upper-threshold scores. Moreover, although this disclosure describes particular upper-threshold scores determined in a particular manner, this disclosure contemplates any suitable upper-threshold scores determined in any suitable manner.

In particular embodiments, an upper-threshold score associated with a scoring axis may be based on a particular percentage of scores associated with the scoring axis. In particular embodiments, an upper-threshold score may be greater than a particular percentage of scores associated with a scoring axis. As an example and not by way of limitation, an upper-threshold score may be greater than approximately 60%, 70%, 80%, 90%, or any suitable percentage of scores associated with a particular scoring axis. For example, an upper-threshold score at the 90th percentile of a set of 200 scores may result in objects associated with the top 10% of scores (or the top 20 scores) being retained in the set of objects. In the example of FIG. 4, an upper-threshold score associated with the social-relevance axis may be greater than approximately 75% of the scores for that axis, or greater than the five lowest scores. In this case, a threshold score greater than approximately 75% of the scores may have a value of 8, and the two objects with social-relevance scores above 8 (object_4 and object_5) may be retained in the set of seven identified objects. Although this disclosure describes retaining particular objects based on particular percentages of scores associated with a scoring axis, this disclosure contemplates retaining any suitable objects based on any suitable percentages of scores associated with a scoring axis.

In particular embodiments, an upper-threshold score associated with a scoring axis may be less than a particular number of scores associated with that scoring axis. As an example and not by way of limitation, an upper-threshold score may be less than the top 10, 20, 50, 100, or any suitable number of scores associated with a particular scoring axis. For example, an upper-threshold score less than the top 50 scores of a set of 300 scores may result in objects associated with the top 50 scores being retained in the set of objects. In the example of FIG. 4, an upper-threshold score associated with the author-quality axis may be selected to retain objects associated with the top two scores. In this case, an upper-threshold score associated with the author-quality axis may be set to 8.5, resulting in object_1 and object_5 being retained in the set of identified objects. Although this disclosure describes retaining particular numbers of top-scoring objects, this disclosure contemplates retaining any suitable number of top-scoring objects.

In particular embodiments, an identified object may be retained in a set of identified objects if it is associated with two or more scores for two or more scoring axes, respectively, above the upper-threshold scores of the scoring axes. As an example and not by way of limitation, an object may be retained in a set of objects if two of its scores are greater than two respective upper-threshold scores. In the example of FIG. 4, the recency axis may have an upper-threshold score of 8.5, and the text-similarity axis may have an upper-threshold score of 8. In this case, object_2 may be retained since both its recency score (9) is greater than the upper-threshold score 8.5 and its text-similarity score (9) is greater than the upper-threshold score 8. In the example of FIG. 4, object_1 may not be retained since, even though its recency score (10) is greater than the upper-threshold score 8.5, its text-similarity score (6) is below the upper-threshold score 8. Although this disclosure describes retaining particular objects based on particular numbers of scores being greater than particular upper-threshold scores, this disclosure contemplates retaining any suitable objects based on any suitable numbers of scores being greater than any suitable upper-threshold scores.

### Generating and Sending Search Results

In particular embodiments, social-networking system 160 may generate one or more search results corresponding to one or more of the identified objects remaining in the set of objects, respectively, each search result including a reference to a corresponding identified object. The search results can be sorted in any suitable order (e.g., chronologically or by a ranking score) and then presented to the user. The search results (e.g., the identified nodes or their corresponding profile pages) may be scored (or ranked) and presented to the user according to their relative degrees of relevance to the search query, as determined by the particular search algorithm used to generate the search results. The search results may also be scored and presented to the user according to their relative degree of relevance to the user. The search results may be scored or ranked based on one or more factors (e.g., match to the search query or other query constraints, social-graph affinity, search history, etc.), and the top 5, 10, 20, 50, or any suitable number of results may then be generated as search results for presentation to the querying user. In particular embodiments, social-networking system 160 may only send search results having a score/rank over a particular threshold score/rank. As an example and not by way of limitation, social-networking system 160 may only send the top ten results back to the querying user in response to a particular search query. Although this disclosure describes generating particular search results in a particular manner, this disclosure contemplates generating any suitable search results in any suitable manner.

In particular embodiments, social-networking system 160 may send, responsive to the query, one or more search results for display to the querying user. The search results may be sent to the user, for example, in the form of a list of links on a search-results webpage, each link being associated with a different webpage that contains some of the identified resources or content. In particular embodiments, each link in the search results may be in the form of a Uniform Resource Locator (URL) that specifies where the corresponding webpage is located and the mechanism for retrieving it. Social-networking system 160 may then send the search-results webpage to the web browser 132 on the user's client system 130. The user may then click on the URL links or otherwise select the content from the search-results webpage to access the content from social-networking system 160 or from an external system (such as, for example, third-party system 170), as appropriate. In particular embodiments, each search result may include a link to a profile page and a description or summary of the profile page (or the node corresponding to that page). The search results may be presented and sent to the querying user as a search-results page. When generating the search results, social-networking system 160 may generate and send to the querying user one or more snippets for each search result, where the snippets are contextual information about the target of the search result (i.e., contextual information about the social-graph entity, profile page, or other content corresponding to the particular search result). Although this disclosure describes sending particular search results in a particular manner, this disclosure contemplates sending any suitable search results in any suitable manner.

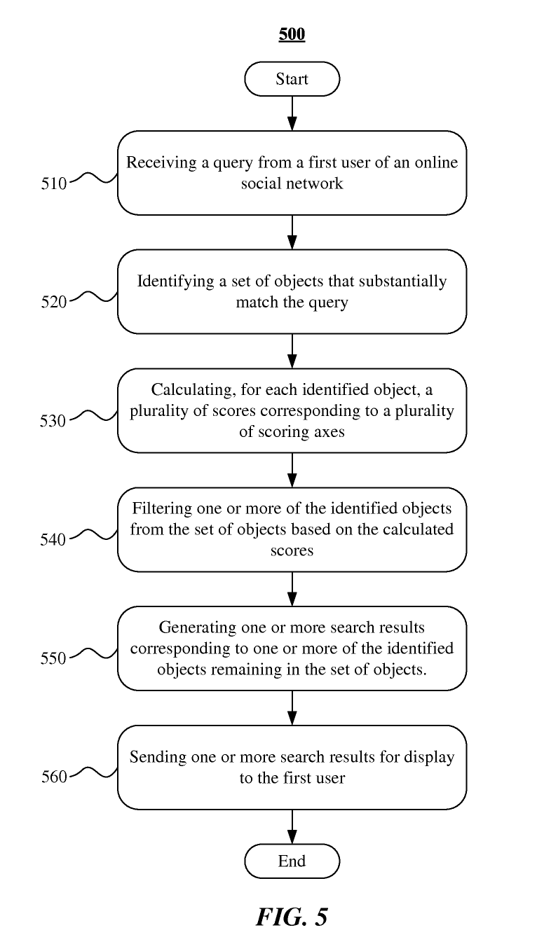

FIG. 5 illustrates an example method 500 for generating search results in response to a query. The method may begin at step 510, where social-networking system 160 may receive a query from a first user of an online social network hosted by social-networking system 160. In particular embodiments, social-networking system 160 may access a social graph 200 comprising a plurality of nodes (e.g., user nodes 202 or concept nodes 204) and a plurality of edges 206 connecting the nodes. Each edge between two nodes may represent a single degree of separation between them. The nodes may comprise a first node (e.g., a first user node 202) corresponding to a first user associated with the online social network. The nodes may also comprise a plurality of second nodes that each correspond to an object associated with the online social network. At step 520, social-networking system 160 may identify a set of objects associated with the online social network that substantially match the query. At step 530, social-networking system 160 may calculate, for each identified object, a plurality of scores corresponding to a plurality of scoring axes, respectively. In particular embodiments, each scoring axis may have a threshold score that is statistically determined for the scoring axis. At step 540, social-networking system 160 may filter one or more of the identified objects from the set of objects based on the calculated scores. In particular embodiments, each filtered object may be associated with one or more scores for one or more scoring axes, respectively, below the threshold score of the respective scoring axis. At step 550, social-networking system 160 may generate one or more search results corresponding to one or more of the identified objects remaining in the set of objects, respectively. In particular embodiments, each search result may comprise a reference to a corresponding identified object. At step 560, social-networking system 160 may send, responsive to the query, one or more search results for display to the first user, at which point the method may end. Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for generating search results in response to a query including the particular steps of the method of FIG. 5, this disclosure contemplates any suitable method for generating search results in response to a query including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Social Graph Affinity and Coefficient

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user may make frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Systems and Methods

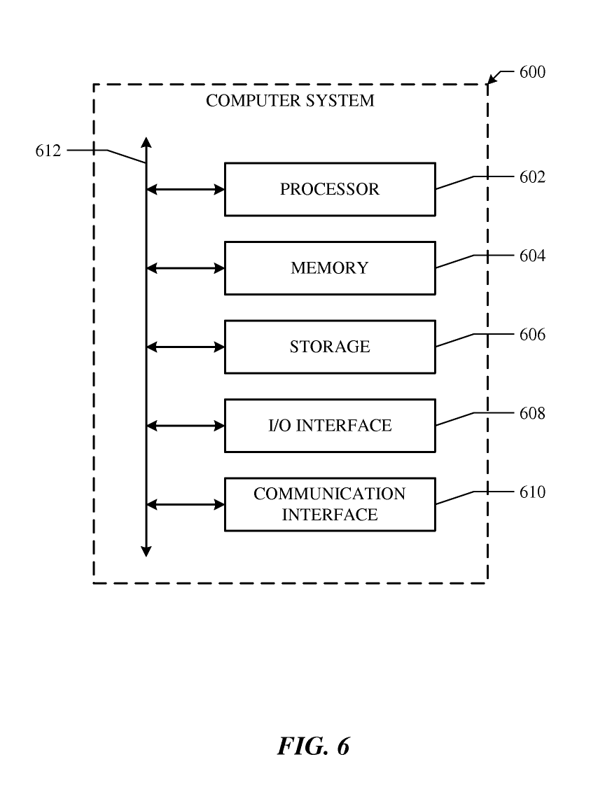

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on- module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

[82] In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more computing devices:
receiving a query from a first user of an online social network;
identifying a set of objects associated with the online social network that substantially match the query;
calculating, for each identified object, a plurality of scores corresponding to a plurality of scoring axes, respectively, each scoring axis having a threshold score that is statistically determined for the scoring axis;
filtering one or more of the identified objects from the set of objects based on the calculated scores, wherein each filtered object is associated with one or more scores for one or more scoring axes, respectively, below the threshold score of the respective scoring axis;
generating one or more search results corresponding to one or more of the identified objects remaining in the set of objects, respectively, each search result comprising a reference to a corresponding identified object; and
sending, responsive to the query, one or more search results for display to the first user.

2. The method of claim 1, further comprising:
accessing a social graph comprising a plurality of nodes and a plurality of edges connecting the nodes, each of the edges between two of the nodes representing a single degree of separation between them, the nodes comprising:
a first node corresponding to the first user associated with the online social network; and
a plurality of second nodes that each correspond to an object associated with the online social network.

3. The method of claim 2, wherein, for each identified object, the score corresponding to a scoring axis is based at least in part on a degree of separation between the first node and a second node corresponding to the identified object.

4. The method of claim 1, wherein, for each identified object, the score corresponding to a scoring axis is based at least in part on a social-graph affinity of the first user with respect to the identified object.

5. The method of claim 1, wherein, for each identified object, the score corresponding to a scoring axis is based at least in part on a recency value associated with the identified object.

6. The method of claim 1, wherein, for each identified object, the score corresponding to a scoring axis is based at least in part on a calculated topic relevance for the identified object with respect to the query.

7. The method of claim 1, wherein, for each identified object, the score corresponding to a scoring axis is based at least in part on a calculated author quality associated with the identified object.

8. The method of claim 1, wherein, for each identified object, the score corresponding to a scoring axis is based at least in part on a calculated text similarity between the identified object and the query.

9. The method of claim 1, wherein the threshold score associated with a scoring axis is a number of standard deviations below a mean of scores associated with the scoring axis.

10. The method of claim 1, wherein the threshold score associated with a scoring axis is greater than a percentage of scores associated with the scoring axis.

11. The method of claim 1, wherein the threshold score associated with a scoring axis is greater than a number of scores associated with the scoring axis.

12. The method of claim 1, wherein an identified object is filtered from the set of objects if it is associated with two or more scores for two or more scoring axes, respectively, below the threshold scores of the scoring axes.

13. The method of claim 1, wherein the threshold score associated with a scoring axis is based on a step function associated with the scores for the scoring axis.

14. The method of claim 1, further comprising retaining in the set of objects one or more of the identified objects whose scores associated with one or more scoring axes are above one or more respective upper-threshold scores.

15. The method of claim 14, wherein the upper-threshold score associated with a scoring axis is greater than a percentage of scores associated with the scoring axis.

16. The method of claim 14, wherein the upper-threshold score associated with a scoring axis is less than a number of scores associated with the scoring axis.

17. The method of claim 14, wherein an identified object is retained in the set of objects if it is associated with two or more scores for two or more scoring axes, respectively, above the upper-threshold scores of the scoring axes.

18. The method of claim 1, further comprising determining, for each scoring axis, a threshold score, the threshold score based at least in part on the calculated scores associated with the scoring axis.

19. One or more computer-readable non-transitory storage media embodying software that is operable when executed to:
receive a query from a first user of an online social network;
identify a set of objects associated with the online social network that substantially match the query;
calculate, for each identified object, a plurality of scores corresponding to a plurality of scoring axes, respectively, each scoring axis having a threshold score that is statistically determined for the scoring axis;
filter one or more of the identified objects from the set of objects based on the calculated scores, wherein each filtered object is associated with one or more scores for one or more scoring axes, respectively, below the threshold score of the respective scoring axis;
generate one or more search results corresponding to one or more of the identified objects remaining in the set of objects, respectively, each search result comprising a reference to a corresponding identified object; and
send, responsive to the query, one or more search results for display to the first user.

20. A system comprising: one or more processors; and a memory coupled to the processors comprising instructions executable by the processors, the processors operable when executing the instructions to:
receive a query from a first user of an online social network;
identify a set of objects associated with the online social network that substantially match the query;
calculate, for each identified object, a plurality of scores corresponding to a plurality of scoring axes, respectively, each scoring axis having a threshold score that is statistically determined for the scoring axis;
filter one or more of the identified objects from the set of objects based on the calculated scores, wherein each filtered object is associated with one or more scores for one or more scoring axes, respectively, below the threshold score of the respective scoring axis;
generate one or more search results corresponding to one or more of the identified objects remaining in the set of objects, respectively, each search result comprising a reference to a corresponding identified object; and
send, responsive to the query, one or more search results for display to the first user.
